(19) United States
(12) Patent Application Publication
(10) Pub. No.: US 2025/0021954 A1
(43) Pub. Date: Jan. 16, 2025

(54) METHODS OF GENERATING COLLECTABLE NON-FUNGIBLE TOKENS

(71) Applicant: FanVant, Inc., New York, NY (US)

(72) Inventor: Michael Angelo Genova, III, New York, NY (US)

(21) Appl. No.: 18/585,244

(22) Filed: Feb. 23, 2024

Related U.S. Application Data
(63) Continuation of application No. PCT/US2022/041146, filed on Aug. 23, 2022.
(60) Provisional application No. 63/236,482, filed on Aug. 24, 2021.

(51) Int. Cl. G06Q 20/12; G06F 16/48; G06F 16/487

(52) U.S. Cl. CPC G06Q 20/123; G06F 16/487; G06F 16/489; G06Q 2220/00

(57) ABSTRACT

The present disclosure describes a computer-implemented method for generating a non-fungible token (NFT) of an individual and/or an experience between the user and the individual, comprising obtaining a set of pre-determined criteria relating to the experience between the user and the individual; obtaining a first set of location information and time information of the user and a second set of location information and time information of the individual; processing the first set of location information and time information and the second set of location information and time information using the set of pre-determined criteria; and generating the NFT of the individual and/or the experience based at least in part on the processing.

### CROSS-REFERENCE

This application is a continuation of International Application No. PCT/US2022/041146,filed Aug. 23, 2022, which claims the benefit of U.S. Provisional Application No. 63/236,482,filed Aug. 24, 2021, each of which is incorporated by reference herein in its entirety.

### BACKGROUND

A non-fungible token (NFT) may be a unit of data stored on a digital ledger that certifies a digital asset. An NFT can represent ownership of items. Virtually any type of real or intangible items may be represented, including but not limited to: art, music, video, and collectibles. NFTs may be bought, sold, traded between entities like any good that is in digital form, any good that can be digitalized, or any good that can be represented in digital form.

### SUMMARY

In some aspects, the present disclosure provides a computer-implemented method for generating a non-fungible token (NFT) of an individual and/or an experience between the user and the individual, comprising: (a) obtaining a set of pre-determined criteria relating to the experience between the user and the individual: (b) obtaining a first set of location information and time information of the user and a second set of location information and time information of the individual: (c) processing the first set of location information and time information and the second set of location information and time information using the set of pre-determined criteria: and (d) generating the NFT of the individual and/or the experience based at least in part on the processing in (c).

In some embodiments, the individual is an entertainer.

In some embodiments, the entertainer is an athlete, an actor, an artist, a musician, a singer, or a dancer.

In some embodiments, the entertainer is an athlete.

In some embodiments, the NFT comprises a single-faced graphical representation.

In some embodiments, the single-faced graphical representation comprises an image file, an audio file, or a video file.

In some embodiments, the image file comprises at least one of an image of the individual, an image created by the individual, location information of the individual, time information of the individual, and an authentication of the NFT.

In some embodiments, the audio file comprises at least one of audio of the individual, audio created by the individual, location information of the individual, time information of the individual, and an authentication of the NFT.

In some embodiments, the video file comprises at least one of a video of the individual, a video created by the individual, location information of the individual, time information of the individual, and an authentication of the NFT.

In some embodiments, the NFT comprises a multi-faced graphical representation.

In some embodiments, the multi-faced graphical representation comprises a plurality of image files, audio files, and/or video files.

In some embodiments, the experience relates to an interaction and/or a proximity

between the user and the individual.

In some embodiments, the set of pre-determined criteria relating to the interaction and/or proximity comprises a criterion that the user is required to be within a pre-determined distance proximal to the individual.

In some embodiments, the pre-determined distance is within about 1,000 feet, about 500feet, about 200 feet, about 100 feet, about 50 feet, about 40 feet, about 30 feet, about 20 feet, or about 10 feet.

In some embodiments, the set of pre-determined criteria relating to the interaction and/or proximity comprises a criterion that the user is required to be attending an entertainment event of the individual.

In some embodiments, the entertainment event comprises a sports event or an artistic event.

In some embodiments, the entertainment event comprises the sports event.

In some embodiments, the sports event is a golf game, a football game, a baseball game, a basketball game, a soccer game, a tennis game, a running competition, a swimming competition, a bicycling competition, a motorsport, a winter sport, or a volley ball game.

In some embodiments, the entertainment event comprises the artistic event.

In some embodiments, the artistic event is a concert, a dance performance, or a theatrical production.

In some embodiments, (b) comprises using a beacon or a global positioning system (GPS) to obtain location information and/or time information of the user and/or the individual.

In some embodiments, (b) is performed using a smartphone or a smartwatch of the user.

In some embodiments, (d) comprises incorporating user generated content of the user.

In some embodiments, the user generated content comprises an image or a video of the user and/or the individual.

In some embodiments, the computer-implemented method further comprises transmitting the NFT of the individual and/or the experience to the user.

In some embodiments, the computer-implemented method further comprises generating a plurality of NFTs of the individual and/or the experience.

In some embodiments, the computer-implemented method further comprises generating at least one of a numerical identifier, a date identifier, and a time identifier for the NFT.

In some embodiments, the computer-implemented method further comprises generating an authentication of the NFT.

In some embodiments, the authentication is generated using a blockchain.

In some embodiments, the computer-implemented method further comprises generating a sale of the NFT.

In some embodiments, the sale is completed using a blockchain.

In some embodiments, the computer-implemented method further comprises notifying the user to redeem the NFT.

In some embodiments, the NFT comprises an image or a photograph modified with a machine learning filter.

In some embodiments, the NFT comprises or is associated with a meta data, wherein the meta data comprises: (i) a coordinate based on the set of location information, (ii) a title of an event, (iii) a description of the event, or (iv) a number of copies of the NFT generated.

In some aspects, the present disclosure provides a non-transitory computer-readable storage medium encoded with a computer program including instructions executable by a processor to perform a method for generating a non-fungible token (NFT) of an individual and/or an experience between the user and the individual, the method comprising: (a) obtaining a set of pre-determined criteria relating to the experience between the user and the individual: (b) obtaining a first set of location information and time information of the user and a second set of location information and time information of the individual: (c) computer processing the first set location information and time information and the second set of location information and time information using the set of pre-determined criteria: and (d) generating the NFT of the individual and/or the experience based at least in part on the computer processing in (c).

In some aspects, the present disclosure provides a computer program product comprising a computer-readable medium having computer-executable code encoded therein, the computer-executable code adapted to be executed to perform a method for generating a non-fungible token (NFT) of an individual and/or an experience between the user and the individual, the method comprising: (a) obtaining a set of pre-determined criteria relating to the experience between the user and the individual: (b) obtaining a first set of location information and time information of the user and a second set of location information and time information of the individual: (c) computer processing the first set location information and time information and the second set of location information and time information using the set of pre-determined criteria: and (d) generating the NFT of the individual and/or the experience based at least in part on the computer processing in (c).

In some aspects, the present disclosure provides a computer-implemented system comprising: a digital processing device comprising: at least one processor, an operating system configured to perform executable instructions, a memory, and a computer program including instructions executable by the digital processing device to perform a method for generating a non-fungible token (NFT) of an individual/or an experience between the user and the individual, the method comprising: (a) obtaining a set of pre-determined criteria relating to an experience between the user and the individual: (b) obtaining a first set of location information and time information of the user and a second set of location information and time information of the individual: (c) computer processing the first set location information and time information and the second set of location information and time information using the set of pre-determined criteria: and (d) generating the NFT of the individual and/or the experience based at least in part on the computer processing in (c).

In some aspects, the present disclosure provides a computer-implemented method for generating a non-fungible token (NFT) of an objective, comprising: (a) obtaining a set of pre-determined criteria relating to interaction and/or proximity between a user and the objective: (b) obtaining a first set of location information and time information of the user: (c) processing the first set of location information and time information using the set of pre-determined criteria: and (d) determining that the user and the objective has interacted at least 2 times in separate locations or separate days: (e) generating the NFT of the objective based at least in part on the processing in (c).

In some embodiments, the objective comprises an inanimate object.

In some embodiments, the objective comprises a computer.

In some embodiments, the objective comprises a mobile computer.

In some embodiments, the objective is at a location, wherein the location comprises a golf course, a stadium, a track, an alley, or any combination thereof.

In some embodiments, the objective comprises a display case, a monument, a sculpture, a fighting ring, an art piece, or any combination thereof.

In some embodiments, the NFT comprises a single-faced graphical representation.

In some embodiments, the single-faced graphical representation comprises an image file, an audio file, or a video file.

In some embodiments, the image file comprises at least one of an image of the objective, an image created by the objective, location information of the objective, time information of the objective, and an authentication of the NFT.

In some embodiments, the audio file comprises at least one of audio of the objective, audio created by the objective, location information of the objective, time information of the objective, and an authentication of the NFT.

In some embodiments, the video file comprises at least one of a video of the objective, a video created by the objective, location information of the objective, time information of the objective, and an authentication of the NFT.

In some embodiments, the NFT comprises a multi-faced graphical representation.

In some embodiments, the multi-faced graphical representation comprises a plurality of image files, audio files, and/or video files.

In some embodiments, the set of pre-determined criteria relating to interaction and/or proximity comprises a criterion that the user is required to be within a pre-determined distance proximal to the objective.

In some embodiments, the pre-determined distance is within about 1,000 feet, about 500feet, about 200 feet, about 100 feet, about 50 feet, about 40 feet, about 30 feet, about 20 feet, or about 10 feet.

In some embodiments, the set of pre-determined criteria relating to interaction and/or proximity comprises a criterion that the user is required to be attending an entertainment event associated with the objective.

In some embodiments, the entertainment event comprises a sports event or an artistic event.

In some embodiments, the entertainment event comprises the sports event.

In some embodiments, the sports event is a golf game, a football game, a baseball game, a basketball game, a soccer game, a tennis game, a running competition, a swimming competition, a bicycling competition, a motorsport, a winter sport, or a volley ball game.

In some embodiments, the entertainment event comprises the artistic event.

In some embodiments, the artistic event is a concert, a dance performance, an art exhibit, a fashion show, or a theatrical production.

In some embodiments, (b) comprises using a beacon or a global positioning system (GPS) to obtain location information and/or time information of the user and/or the objective.

In some embodiments. (b) is performed using a smartphone or a smartwatch of the user.

In some embodiments. (d) comprises incorporating user generated content of the user.

In some embodiments, the user generated content comprises an image or a video of the user and/or the objective.

In some embodiments, the computer-implemented method further comprises transmitting the NFT of the objective to the user.

In some embodiments, the computer-implemented method further comprises generating a plurality of NFTs of the objective.

In some embodiments, the computer-implemented method further comprises generating at least one of a numerical identifier, a date identifier, and a time identifier for the NFT.

In some embodiments, the computer-implemented method further comprises generating an authentication of the NFT.

In some embodiments, the authentication is generated using a blockchain.

In some embodiments, the computer-implemented method further comprises generating a sale of the NFT.

In some embodiments, the sale is completed using a blockchain.

In some embodiments, the computer-implemented method further comprises notifying the user to redeem the NFT.

In some embodiments, the NFT comprises or is associated with a meta data, wherein the meta data comprises: (i) a coordinate based on the set of location information, (ii) a title of an event, (iii) a description of the event, or (iv) a number of copies of the NFT generated.

In some aspects, the present disclosure provides a non-transitory computer-readable storage medium encoded with a computer program including instructions executable by a processor to perform a method for generating a non-fungible token (NFT) of an objective, the method comprising: (a) obtaining a set of pre-determined criteria relating to interaction and/or proximity between a user and the objective: (b) obtaining a first set of location information and time information of the user and a second set of location information and time information of the objective: (c) computer processing the first set location information and time information and the second set of location information and time information using the set of pre-determined criteria: and (d) generating the NFT of the objective based at least in part on the computer processing in (c).

In some aspects, the present disclosure provides a computer program product comprising a computer-readable medium having computer-executable code encoded therein, the computer-executable code adapted to be executed to perform a method for generating a non-fungible token (NFT) of an objective, the method comprising: (a) obtaining a set of pre-determined criteria relating to interaction and/or proximity between a user and the objective: (b) obtaining a first set of location information and time information of the user and a second set of location information and time information of the objective: (c) computer processing the first set location information and time information and the second set of location information and time information using the set of pre-determined criteria: and (d) generating the NFT of the objective based at least in part on the computer processing in (c).

In some aspects, the present disclosure provides a computer-implemented system comprising: a digital processing device comprising: at least one processor, an operating system configured to perform executable instructions, a memory, and a computer program including instructions executable by the digital processing device to perform a method for generating a non-fungible token (NFT) of an objective, the method comprising: (a) obtaining a set of pre-determined criteria relating to interaction and/or proximity between a user and the objective: (b) obtaining a first set of location information and time information of the user and a second set of location information and time information of the objective; (c) computer processing the first set location information and time information and the second set of location information and time information using the set of pre-determined criteria; and (d) generating the NFT of the objective based at least in part on the computer processing in (c).

In some aspects, the present disclosure provides a computer-implemented method for generating a non-fungible token (NFT) of an objective, comprising: (a) obtaining a set of pre-determined criteria relating to interaction and/or proximity between a user and the objective; (b) obtaining a first set of location information and time information of the user; (c) processing the first set of location information and time information using the set of pre-determined criteria; (d) determining that the user and the objective has interacted at least 2 times in separate locations or separate days; and (e) generating the NFT of the objective based at least in part on the processing in (c).

In some aspects, the present disclosure provides a user device, comprising: a processor; memory containing a media wallet application; wherein the processor is configured by the media wallet application to securely store an NFT, wherein the NFT comprises a cryptographic token that is created with respect to a graphical content, wherein the cryptographic token is based on a set of pre-determined criteria relating to an experience between a user and an individual, and wherein the experience is based on a first set of location information and time information of the user and a second set of location information and time information of the individual.

In some aspects, the present disclosure provides a user device, comprising: a processor; memory containing a media wallet application; wherein the processor is configured by the media wallet application to generate an NFT, wherein the NFT comprises a cryptographic token that is generated with respect to a graphical content, wherein the cryptographic token is based on a set of pre-determined criteria relating to an experience between a user and an individual, and wherein the experience is based on a first set of location information and time information of the user and a second set of location information and time information of the individual.

In some aspects, the present disclosure provides a user device, comprising: a processor; memory containing a media wallet application; wherein the processor is configured by the media wallet application to transfer an NFT to another media wallet application, wherein the NFT comprises a cryptographic token that is generated with respect to a graphical content, wherein the cryptographic token is based on a set of pre-determined criteria relating to an experience between a user and an individual, and wherein the experience is based on a first set of location information and time information of the user and a second set of location information and time information of the individual.

In some aspects, the present disclosure provides a user device, comprising: a processor; memory containing a media wallet application; wherein the processor is configured by the media wallet application to securely store an NFT, wherein the NFT comprises a cryptographic token that is created with respect to a graphical content, wherein the cryptographic token is based on a set of pre-determined criteria relating to interaction and/or proximity between a user and an objective, and wherein the interaction and/or the proximity is based on a first set of location information and time information of the user and a second set of location information and time information of the objective.

In some aspects, the present disclosure provides a user device, comprising: a processor; memory containing a media wallet application; wherein the processor is configured by the media wallet application to generate an NFT, wherein the NFT comprises a cryptographic token that is generated with respect to a graphical content, wherein the cryptographic token is based on a set of pre-determined criteria relating to interaction and/or proximity between a user and an objective, and wherein the interaction and/or the proximity is based on a first set of location information and time information of the user and a second set of location information and time information of the objective.

In some aspects, the present disclosure provides a user device, comprising: a processor; memory containing a media wallet application; wherein the processor is configured by the media wallet application to transfer an NFT to another media wallet application, wherein the NFT comprises a cryptographic token that is generated with respect to a graphical content, wherein the cryptographic token is based on a set of pre-determined criteria relating to interaction and/or proximity between a user and an objective, and wherein the interaction and/or the proximity is based on a first set of location information and time information of the user and a second set of location information and time information of the objective.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIGS. 1A-1C show an example of a notification, a graphical user interface (GUI) for collecting an NFT, and a GUI showing badges and moments, respectively.

FIGS. 2A-2B show an example of a multi-faced and mixed-media NFT.

FIGS. 3A-3C show examples of an NFT with meta data.

FIGS. 4A-4C show an example of a notification, a GUI for collecting an NFT, and a GUI showing badges and moments, respectively.

FIGS. 5A-5C show an example of a notification, a GUI for collecting an NFT, and a GUI showing badges and moments, respectively.

FIGS. 6A-6D show an example of a notification, a GUI for collecting an NFT, an NFT, and a GUI showing badges and moments, respectively.

FIG. 7 illustrates a computer system that is programmed or otherwise configured to implement methods provided herein.

FIG. 8 shows an example of a method 800 for generating an NFT of an individual and/or an experience between a user and an individual based on interaction and/or proximity between a user and an individual.

FIG. 9 shows an example of a method 900 for generating an NFT of an objective based on interaction and/or proximity between a user and an objective.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used in the specification and claims, the singular form “a”, “an”, and “the” include plural references unless the context clearly dictates otherwise. For example, the term “an NFT” includes a plurality of NFTs, including combinations of NFTs with other digital forms.

NFTs may refer to tokens that can be used to represent ownership of items. Virtually any type of real or intangible items may be represented, including but not limited to: art, music, video, and collectibles. NFTs may be bought, sold, traded between entities like any good that is in digital form, any good that can be digitalized, or any good that can be represented in digital form.

In some aspects, provided herein are systems and methods for generating NFTs based on interactions between a user and an objective. The objective can be, for example, a celebrity athlete, such that an interaction between the user and the athlete can be memorialized with the NFT, which creates a digital product comprising value. For instance, the NFT can carry psychological value (e.g., a positive memory for the user), functional value (e.g., an aesthetically pleasing NFT), monetary value (e.g., rarity, provenance, and/or exclusivity driven by demand), and/or social value (e.g., proof of the interaction with the objective). By being a verifiable asset, an NFT can provide proof of interaction with the objective that is difficult, if not nearly impossible, to forge.

In an aspect, the present disclosure describes a computer-implemented method for generating a non-fungible token (NFT) of an individual and/or an experience between the user and the individual. In some embodiments, the computer-implemented method can comprise obtaining a set of pre-determined criteria relating to interaction and/or proximity between a user and the individual. In some embodiments, the computer-implemented method can comprise obtaining a first set of location information and time information of the user and a second set of location information and time information of the individual. In some embodiments, the computer-implemented method can comprise processing the first set location information and time information and the second set of location information and time information using the set of pre-determined criteria. In some embodiments, the computer-implemented method can comprise generating the NFT of the individual based at least in part on the processing. The NFT can be generated when a verifiable interaction has occurred between the user and the individual.

For example, the NFT may comprise characteristics of an individual (e.g., similar to a baseball card that includes an athlete's image and statistics). As another example, the NFT may comprise characteristics of an experience between the user and the individual (e.g., an experience badge, which memorializes the user's image and accomplishment relative to the individual's interactions). As another example, the NFT may comprise a combination of characteristics of the individual and characteristics of the experience.

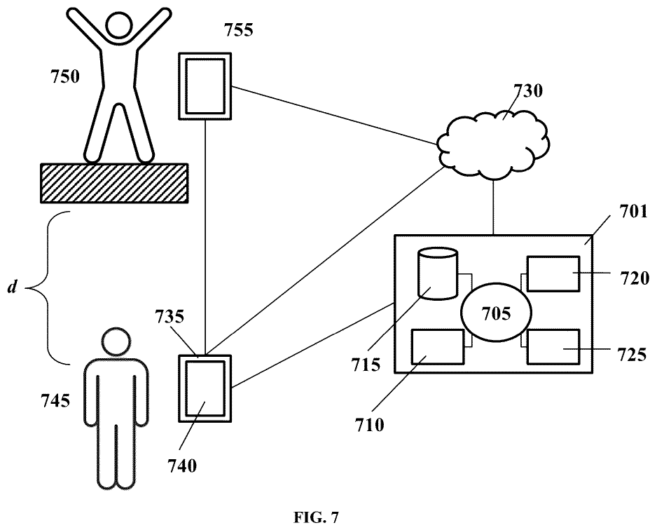

FIG. 7 illustrates a computer system that is programmed or otherwise configured to implement methods provided herein. A user (745) can be in proximity to an objective (750), which can be an individual. The proximity can be based on a distance between the user and the objective. The proximity can be based on a distance between the user's electronic device (735) and the electronic device (755) associated with the objective. When it can be determined that the user and the objective are proximal, an NFT can be generated to memorialize an interaction between the user and the objective. Other criteria can be also used to determine if an interaction has taken place between the user and the objective, for example, if the user is in the same venue, the same event, or when any other criteria is used as a basis for establishing a connection between the user and the objective. The proximity and/or any other criteria can be processed locally. e.g., between the electronic devices of the user and the objective, to generate the NFT. In some cases, the proximity and/or any other criteria can be processed using non-local computers, e.g., cloud computing, servers, etc., to generate the NFT. The NFT can be stored on a public ledger that can be verified by various entities.

Proximity between the user and the individual may comprise any spatial measure of proximity between the user and the individual without departing from concepts provided herein. In some embodiments, proximity may comprise a distance of at most about 1, 2, 3, 4, 5, 6, 7, 8,9, 10, 20, 30, 40, 50, 60, 70, 80, 90, 100, 200, 300, 400, 500, 600, 700, 800, 900, or 1000 feet. In some embodiments, proximity may comprise a distance of at most about 1, 2, 3, 4, 5, 6, 7, 8, 9,10, 20, 30, 40, 50, 60, 70, 80, 90, 100, 200, 300, 400, 500, 600, 700, 800, 900, or 1000 meters. In some embodiments, proximity may comprise a distance of at least about 1, 2, 3, 4, 5, 6, 7, 8, 9,10, 20, 30, 40, 50, 60, 70, 80, 90, 100, 200, 300, 400, 500, 600, 700, 800, 900, or 1000 feet. In some embodiments, proximity may comprise a distance of at least about 1, 2, 3, 4, 5, 6, 7, 8, 9,10, 20, 30, 40, 50, 60, 70, 80, 90, 100, 200, 300, 400, 500, 600, 700, 800, 900, or 1000 meters. In some embodiments, proximity may comprise the user and the individual being at a same venue, wherein the venue may comprise a stadium, a golf course, a restaurant, a concert hall, a bar, a race track, a ship, or any other venue that the user may be proximal to the individual. The proximity can be based on a virtual environment, for example, in virtual reality.

Interaction between the user and the individual may comprise various forms of digital interactions without departing from the concepts provided herein. In some embodiments, interaction may comprise a communication between an electronic device of the user and an electronic device of the individual. In some embodiments, interaction may comprise both the user and the individual logging into a same communication channel, for instance, a virtual concert. Interaction between the user and the individual may comprise various forms of interactions that are non-digital (i.e., “in real-life”) without departing from the concepts provided herein.

The individual may comprise any entertainer, celebrity, and the like from which users of some of the systems and methods described herein may derive value in interacting with or being proximal to, without departing from the concepts disclosed herein. In some embodiments, the individual may comprise an entertainer. In some embodiments, the individual may comprise a group of entertainers. In some embodiments, an entertainer may comprise an athlete, an actor, an actress, an artist, a musician, a singer, or a dancer.

The set of pre-determined criteria relating to interaction and/or proximity may comprise any criterion based at least partially on spatially proximity without departing from the concepts provided herein. The set of pre-determined criteria relating to interaction and/or proximity may comprise any criterion based at least partially on a recordable interaction between the user and the individual without departing from the concepts provided herein. In some embodiments, the set of pre-determined criteria relating to interaction and/or proximity comprises a criterion that the user is required to be within a pre-determined distance proximal to the individual. In some embodiments, the pre-determined distance is within about 1,000 feet, about 500 feet, about 200feet, about 100 feet, about 50 feet, about 40 feet, about 30 feet, about 20 feet, or about 10 feet. In some embodiments, the set of pre-determined criteria relating to interaction and/or proximity comprises a criterion that the user is required to be attending an entertainment event of the individual. In some embodiments, the entertainment event comprises a sports event or an artistic event. In some embodiments, the sports event is a golf game, a football game, a baseball game, a basketball game, a soccer game, a tennis game, a running competition, a swimming competition, a bicycling competition, a motorsport, a winter sport, or a volleyball game. In some embodiments, the entertainment event comprises the artistic event. In some embodiments, the artistic event is a concert, a dance performance, or a theatrical production. In some embodiments, the set of pre-determined criteria may be based at least partially on proximity in virtual space.

The first set of location information and time information of the user and the second set of location information and time information of the individual may each comprise various types of information that places the user or the individual at various locations and/or various times as obtained through various means without departing from the concepts provided herein. In some embodiments, a location information may comprise a GPS location. In some embodiments, the information may comprise presence at a venue, a sports event, an entertainment event, a virtual event, a concert, a dance performance, or a theatrical production at a certain year, month, week, day, hour, minute, second, or any combination thereof. In some embodiments, the obtaining may comprise obtaining using a beacon or a global position system. In some embodiments, the obtaining may comprise obtaining using a beacon or a global position system of the user. In some embodiments, the obtaining may comprise obtaining using a beacon or a global position system of the individual. In some embodiments, the obtaining may comprise obtaining using a a smartphone or a smartwatch. In some embodiments, obtaining may comprise obtaining using a smartphone or a smartwatch of the user. In some embodiments, obtaining may comprise obtaining using a smartphone or a smartwatch of the individual.

In some embodiments, generating the NFT of the individual based at least in part on the processing may comprise incorporating user generated content of the user. User generated content of the user may comprise various digital forms and may be created at any moment in time at any location without departing from the concepts provided herein. In some embodiments, the user generated content comprises an image or a video of the user and/or the individual. In some embodiments, the user generated content comprises user generated art. In some embodiments, the user generated content comprises user generated music. In some embodiments, the user generated content may capture a moment or a duration of time in which some users of the methods described herein may place value on. In some embodiments, a user generated content may capture a scoring event, a game-winning event, or other significant fan experience event of a game through a image or a video. In some embodiments, a user generated content may capture a game-winning putt of a golfing tournament through an image or a video. In some embodiments, a user generated content may capture a game-winning shot of a basketball game through an image or a video. In some embodiments, a user generated content may capture a homerun hit in a baseball game through an image or a video. In some embodiments, a user generated content may capture a goal in soccer or hockey through an image or a video. In some embodiments, a user generated content may capture sounds of a crowd cheering at the end of a game (e.g., in reaction to a significant fan experience event). In some embodiments, a user generated content may comprise video and audio capture a portion of a live performance.

In some embodiments, the method further comprises transmitting the NFT of the individual to the user. In some embodiments, the transmitting may comprise transmitting the NFT to a digital account of the user. In some embodiments, the transmitting may comprise transmitting a code of the NFT to the user. In some embodiments, the transmitting may comprise transmitting the NFT to a digital wallet of the user. In some embodiments, the transmitting may comprise transmitting the NFT to a mobile app of the user. The transmitting can comprise any one of the methods for transferring NFTs disclosed in U.S. patent application Ser. No. 17/061,254, which is incorporated by reference herein in its entirety.

The method may comprise generating any number of NFTs of the individual without departing from the concepts provided herein. In some embodiments, the method further comprises generating a plurality of NFTs of the individual. In some embodiments, the method may comprise generating at least about 2 NFTs, at least about 3 NFTs, at least about 4 NFTs, at least about 5 NFTs, at least about 6 NFTs, at least about 7 NFTs, at least about 8 NFTs, at least about 9 NFTs, at least about 10 NFTs, at least about 20 NFTs, at least about 30 NFTs, at least about 40 NFTs, at least about 50 NFTs, at least about 60 NFTs, at least about 70 NFTs, at least about 80 NFTs, at least about 90 NFTs, at least about 100 NFTs, at least about 200 NFTs, at least about 300 NFTs, at least about 400 NFTs, at least about 500 NFTs, at least about 600 NFTs, at least about 700 NFTs, at least about 800 NFTs, at least about 900 NFTs, at least about 1000NFTs, at least about 2000 NFTs, at least about 3000 NFTs, at least about 4000 NFTs, at least about 5000 NFTs, at least about 6000 NFTs, at least about 7000 NFTs, at least about 8000 NFTs, at least about 9000 NFTs, at least about 10000 NFTs, at least about 20000 NFTs, at least about 30000 NFTs, at least about 40000 NFTs, at least about 50000 NFTs, at least about 60000 NFTs, at least about 70000 NFTs, at least about 80000 NFTs, at least about 90000 NFTs, or at least about 100000 NFTs.

In some embodiments, the method further comprises generating at least one of a numerical identifier, a date identifier, and a time identifier for the NFT. In some embodiments, a numerical identifier may comprise a number representing a user. In some embodiments, a numerical identifier may comprise an identifier of an individual. In some embodiments, a numerical identifier may comprise a number representing a restaurant. In some embodiments, a numerical identifier may comprise a number representing a concert hall. In some embodiments, a numerical identifier may comprise a number representing a sports venue. In some embodiments, a numerical identifier may comprise a number representing a game. In some embodiments, a numerical identifier may comprise a number representing an event. In some embodiments, a numerical identifier may comprise a number representing virtual event. In some embodiments, a numerical identifier may comprise a number representing a sports event. In some embodiments, a date identifier may comprise a number representing a moment in time. In some embodiments, a date identifier may comprise a number representing some duration of time. In some embodiments, a date identifier may comprise a number representing a date. In some embodiments, a date identifier may comprise a number representing a plurality of dates. In some embodiments, a date identifier may comprise a number representing a year. In some embodiments, a date identifier may comprise a number representing a month. In some embodiments, a date identifier may comprise a number representing a day. In some embodiments, a time identifier may comprise a number representing an hour. In some embodiments, a time identifier may comprise a number representing an hour a minute. In some embodiments, a time identifier may comprise a number representing a second. In some embodiments, a time identifier may comprise a number representing a moment in time. In some embodiments, a time identifier may comprise a number representing a duration in time. In some embodiments, a numerical identifier may be encrypted. In some embodiments, a date identifier may be encrypted. In some embodiments, a time identifier may be encrypted. In some embodiments, a numerical identifier may be put on a blockchain. In some embodiments, a date identifier may be put on a blockchain. In some case, a time identifier may be put on a blockchain.

In some embodiments, the method further comprises generating an authentication of the NFT. In some embodiments, the authentication is generated using a blockchain. Various blockchain technologies may be used to generate an authentication of the NFT without departing from the concepts provided herein. Various methods mining algorithms may be used without departing from the concepts provided herein. In some embodiments, generating an authentication may comprise using a hashing algorithm. In some embodiments, generating an authentication may comprise using an encryption algorithm. In some embodiments, generating an authentication may comprise multiplying two large prime numbers. In some embodiments, generating an authentication may comprise using Bitcoin. In some embodiments, generating an authentication may comprise using Ethereum. In some embodiments, generating an authentication may comprise using Dogecoin. In some embodiments, generating an authentication may comprise using Tether. In some embodiments, generating an authentication may comprise using Binance Coin. In some embodiments, the method further comprises generating an encryption or password protection of the NFT. The NFT can be generated using any one of the methods for generating an NFT disclosed in U.S. patent application Ser. No. 17/061,254 and Ser. No. 16/459,500, which are incorporated by reference in their entirety.

In some embodiments, the method further comprises generating a sale of the NFT. In some embodiments, the sale is completed using a blockchain. A sale may be generated using any blockchain technology. A sale may be generated by trading assets, wherein an asset may comprise an NFT, a cryptocurrency, government issued currency, virtual currency (e.g., in a video game). In some embodiments, generating a sale may comprise using Bitcoin™. In some embodiments, generating a sale may comprise using Ethereum™. In some embodiments, generating an authentication may comprise using Dogecoin™. In some embodiments, generating a sale may comprise trading two assets. In some embodiments, an asset may be an NFT. In some embodiments, a sale may be generated between two users. In some embodiments, a sale may be generated between a user and an individual. In some embodiments, a sale may be generated between a plurality of users. Sales and/or transfers of NFTs can be performed using any one of the sale and/or transfer methods disclosed in in U.S. patent application Ser. No. 17/061,254 and Ser. No. 16/459,500, which are incorporated by reference in their entirety.

An NFT may comprise various graphical or auditory elements or features without departing from the concepts disclosed herein. An NFT may comprise elements or features created by the user, the individual, or any third party without departing from the concepts disclosed herein. An NFT may comprise a variety of information about the individual without departing from the concepts disclosed herein. In some embodiments, an NFT comprises a single-faced graphical representation. In some embodiments, the single-faced graphical representation comprises an image file, an audio file, or a video file. In some embodiments, an image file comprises at least one of an image of the individual, an image created by the individual, a location information of the individual, or a time information of the individual, and an authentication of the NFT. In some embodiments, the audio file comprises at least one of audio of the individual, audio created by the individual, location information of the individual, time information of the individual, and an authentication of the NFT. In some embodiments, the video file comprises at least one of a video of the individual, a video created by the individual, location information of the individual, time information of the individual, and an authentication of the NFT. In some embodiments, the NFT comprises a multi-faced graphical representation. In some embodiments, the multi-faced graphical representation comprises a plurality of image files, audio files, and/or video files. In some embodiments, an NFT comprises an ownership of a single-faced graphical representation. In some embodiments, an NFT comprises an ownership of a multi-faced graphical representation.

In an aspect, the present disclosure describes a computer-implemented method for generating a non-fungible token (NFT) of an objective. In some embodiments, the computer-implemented method can comprise obtaining a set of pre-determined criteria relating to interaction and/or proximity between a user and the objective. In some embodiments, the computer-implemented method can comprise obtaining a first set of location information and time information of the user and a second set of location information and time information of the objective. In some embodiments, the computer-implemented method can comprise processing the first set location information and time information and the second set of location information and time information using the set of pre-determined criteria. In some embodiments, the computer-implemented method can comprise generating the NFT of the objective based at least in part on the processing. In some embodiments, the objective can comprise an individual. In some embodiments, the objective can comprise a venue. In some embodiments, the objective can comprise a restaurant. In some embodiments, the objective can comprise a geocache. In some embodiments, the objective can comprise a target of a scavenger hunt. In some embodiments, the objective can comprise an event, for example, a sporting event or a musical event. In some embodiments, the NFT can be generated when the user interacts with the objective at least a predetermined number of times. The predetermined number of times can comprise at least 1, 2,3, 4, 5, 6, 7, 8, 9, 10, 20, 30, 40, 50, 60, 70, 80, 90, or 100 times.

### Computer Systems

The present disclosure provides computer systems that are programmed to implement methods of the disclosure. FIG. 7 shows a computer system 701 that is programmed or otherwise configured to, for example, generate a non-fungible token (NFT) of an individual and/or an experience between the user and the individual.

The computer system 701 may regulate various aspects of analysis, calculation, and generation of the present disclosure, such as, for example, generating a non-fungible token (NFT) of an individual and/or an experience between the user and the individual. The computer system 701 may be an electronic device of a user or a computer system that is remotely located with respect to the electronic device. The electronic device may be a mobile electronic device.

The computer system 701 includes a central processing unit (CPU, also “processor” and “computer processor” herein) 705, which may be a single core or multi core processor, or a plurality of processors for parallel processing. The computer system 701 also includes memory or memory location 710 (e.g., random-access memory, read-only memory, flash memory), electronic storage unit 715 (e.g., hard disk), communication interface 720 (e.g., network adapter) for communicating with one or more other systems, and peripheral devices 725, such as cache, other memory, data storage and/or electronic display adapters. The memory 710, storage unit 715, interface 720 and peripheral devices 725 are in communication with the CPU 705 through a communication bus (solid lines), such as a motherboard. The storage unit 715 may be a data storage unit (or data repository) for storing data. The computer system 701 may be operatively coupled to a computer network (“network”) 730 with the aid of the communication interface 720. The network 730 may be the Internet, an internet and/or extranet, or an intranet and/or extranet that is in communication with the Internet.

The network 730 in some cases is a telecommunication and/or data network. The network 730 may include one or more computer servers, which may enable distributed computing, such as cloud computing. For example, one or more computer servers may enable cloud computing over the network 730 (“the cloud”) to perform various aspects of analysis, calculation, and generation of the present disclosure, such as, for example, generating a non-fungible token (NFT) of an individual and/or an experience between the user and the individual. Such cloud computing may be provided by cloud computing platforms such as, for example, Amazon Web Services (AWS), Microsoft Azure, Google Cloud Platform, and IBM cloud. The network 730, in some cases with the aid of the computer system 701, may implement a peer-to-peer network. which may enable devices coupled to the computer system 701 to behave as a client or a server.

The CPU 705 may comprise one or more computer processors and/or one or more graphics processing units (GPUs). The CPU 705 may execute a sequence of machine-readable instructions, which may be embodied in a program or software. The instructions may be stored in a memory location, such as the memory 710. The instructions may be directed to the CPU 705, which may subsequently program or otherwise configure the CPU 705 to implement methods of the present disclosure. Examples of operations performed by the CPU 705 may include fetch, decode, execute, and writeback.

The CPU 705 may be part of a circuit, such as an integrated circuit. One or more other components of the system 701 may be included in the circuit. In some cases, the circuit is an application specific integrated circuit (ASIC).

The storage unit 715 may store files, such as drivers, libraries and saved programs. The storage unit 715 may store user data, e.g., user preferences and user programs. The computer system 701 in some cases may include one or more additional data storage units that are external to the computer system 701, such as located on a remote server that is in communication with the computer system 701 through an intranet or the Internet.

The computer system 701 may communicate with one or more remote computer systems through the network 730. For instance, the computer system 701 may communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user may access the computer system 701 via the network 730.

Methods as described herein may be implemented by way of machine (e.g., computer processor) executable code stored on an electronic storage location of the computer system 701, such as, for example, on the memory 710 or electronic storage unit 715. The machine executable or machine readable code may be provided in the form of software. During use, the code may be executed by the processor 705. In some cases, the code may be retrieved from the storage unit 715 and stored on the memory 710 for ready access by the processor 705. In some situations, the electronic storage unit 715 may be precluded, and machine-executable instructions are stored on memory 710.

The code may be pre-compiled and configured for use with a machine having a processer adapted to execute the code, or may be compiled during runtime. The code may be supplied in a programming language that may be selected to enable the code to execute in a pre-compiled or as-compiled fashion.

Aspects of the systems and methods provided herein, such as the computer system 701, may be embodied in programming. Various aspects of the technology may be thought of as “products” or “articles of manufacture” typically in the form of machine (or processor) executable code and/or associated data that is carried on or embodied in a type of machine readable medium. Machine-executable code may be stored on an electronic storage unit, such as memory (e.g., read-only memory, random-access memory, flash memory) or a hard disk. “Storage” type media may include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 701 may include or be in communication with an electronic display 135 that comprises a user interface (UI) 740 for providing, for example, a visual display of an NFT. Examples of UIs include, without limitation, a graphical user interface (GUI) and web-based user interface.

Methods and systems of the present disclosure may be implemented by way of one or more algorithms. An algorithm may be implemented by way of software upon execution by the central processing unit 705. The algorithm can, for example, generate a non-fungible token (NFT) of an individual and/or an experience between the user and the individual.

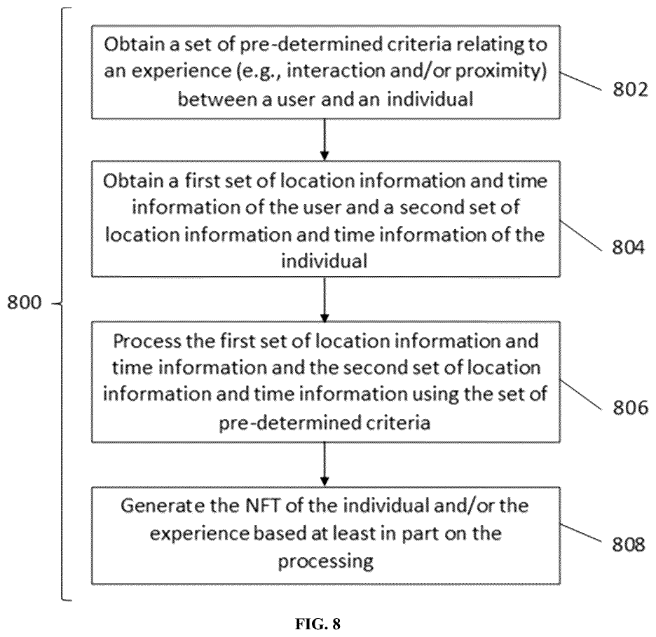

FIG. 8 shows an example of a method 800 for generating an NFT of an individual and/or an experience between the user and the individual based on an experience (e.g., interaction and/or proximity) between a user and an individual. The method 800 may comprise obtaining a set of pre-determined criteria relating to interaction and/or proximity between a user and the individual (as in operation 802). The method 800 may comprise obtaining a first set of location information and time information of the user and a second set of location information and time information of the individual (as in operation 804). The method 800 may comprise processing the first set of location information and time information and the second set of location information and time information using the set of pre-determined criteria (as in operation 806). The method 800 may comprise generating the NFT of the individual and/or the experience based at least in part on the processing (as in operation 808).

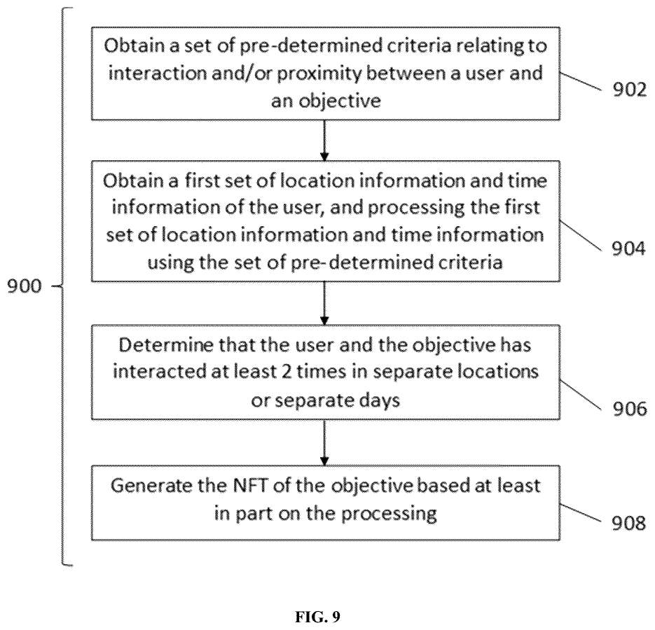

FIG. 9 shows an example of a method 900 for generating an NFT of an objective based on interaction and/or proximity between a user and an objective. The method 900 may comprise obtaining a set of pre-determined criteria relating to interaction and/or proximity between a user and the objective (as in operation 902). The method 900 may comprise obtaining a first set of location information and time information of the user, and processing the first set of location information and time information using the set of pre-determined criteria (as in operation 904). The method 900 may comprise determining that the user and the objective has interacted at least 2 times in separate locations or separate days (as in operation 906). The method 900 may comprise generating the NFT of the objective based at least in part on the processing (as in operation 908).

### EXAMPLES

The following examples are provided to further illustrate some embodiments of the present disclosure, but are not intended to limit the scope of the disclosure; it will be understood by their exemplary nature that other procedures, methodologies, or techniques known to those skilled in the art may alternatively be used.

### Example 1: NFT Generated From a User Interaction With an Individual

A professional golfer and his caddy are participating in an open tournament, wherein the caddy is wearing a wearable device, for example, an electronic watch. The electronic watch is configured with a beacon to generate location data, date data, and time data. Throughout the tournament, the golfer and his caddy travel around the gold course, moving from hole to hole.

Meanwhile a user is observing the professional golfer in the golf tournament and comes within a certain distance of the professional golfer (e.g., 100 ft). A pop-up notification appears on the user's mobile device, indicating that the user is eligible for the professional golfer's NFT. The user can click a button in the app to may generate and receive the NFT comprising an image of the professional golfer. The number of NFTs that may be generated may be limited in number, for instance, so that only up to twenty NFTs may be generated and distributed to a plurality of users. The NFT may be single-faced, comprising a single image. The NFT may be multi-faced, comprising a plurality of images. The NFT may be a video of the professional golfer. The NFT may comprise an augmented reality (AR) element, a virtual reality (VR) element, or both. Sometimes, the NFT may be redeemable only when a user has interacted with the professional golfer a predetermined number of times in different event (e.g., in at least 5 golf tournaments).

### Example 2: NFT Generated by Incorporating User Generated Content

A professional golfer and his caddy are participating in an open tournament, wherein the caddy is wearing a wearable device, for example, an electronic watch. The electronic watch is configured with a beacon to generate location data, date data, and time data. Throughout the tournament, the golfer and his caddy travel around the gold course, moving from hole to hole.

Meanwhile a user is observing the professional golfer in the golf tournament and is using a mobile phone to capture interesting events throughout the course of the tournament. Suppose that a golfer takes the first swing for a hole at a tee box, which ends up being a hole in one. If the user used the mobile phone to capture this moment on video (e.g., from the professional golfer winding up his or her swing, striking the golf ball, the ball flying across the course, and then rolling into the hole), the user can generate a request to generate an NFT based on this video. A predetermine criterion may be checked (e.g., was the user within 50 feet of the wearable device that the caddy is wearing during a duration of time that the video was taken?) If the criterion is met, then the request is sent to a server, wherein an NFT is generated based on the request using metadata associated with the video. The metadata can include a representation of the identity of the professional golfer and time and location data associated with the video.

### Example 3: NFT Generated Based on User Distance to a Fixed Location

A user is geocaching at a well-known location, such as Central Park in New York City. Given a hint about where to find a geocache (e.g., “This person sailed the ocean blue”), the user locates the geocache (e.g., the statue of Christopher Columbus). When the user is with a certain distance of the statue (e.g., 20 feet), as output by a GPS, the user can retrieve an NFT using a mobile application on the user's phone.

### Example 4: NFT Generated Based on User Interaction With an Event

A user buys a ticket to a basketball and goes to the basketball game. Using a web browser, the user may generate an NFT by communicating information about the basketball game (e.g., a number on the ticket). Alternatively, the user may generate an NFT by taking a picture of a QR code (e.g., a QR code on the ticket).

Sometimes, the NFT may be generated only at the basketball game. Generating the NFT may be verified by attending the basketball game, wherein the GPS/LTE location data of the user may be used to confirm that the user is at the game to generate the NFT.

### Example 5: Trades and Sales of NFTs

A mobile application is used as a marketplace for trading or selling NFTs. A user may put an NFTs on the marketplace with an offer. For instance, the user may offer to trade the NFT for a specific NFT of an individual, to sell the NFT for cryptocurrency, to rent the NFT for a certain period of time, or to put up the NFT for auction. A user may search for NFTs on the marketplace using various terms (e.g., name of an individual, price, amount of revenue generated by an NFT), and browse different NFTs that show on the marketplace.

### Example 6: NFT Generated Based on Event Attendance & Athlete/Entertainer Interaction

A user comes within a predefined distance from a target individual (e.g., an athlete or an entertainer) and receives notification that the user is eligible for an NFT memorializing the interaction. The notification can be a badge notification, for instance, which can state “You received a digital autograph from Tiger Woods on X date, at Y location.” The “X” and the “Y” can be the actual date and the actual location of the interaction. The memorialized NFT or a record thereof can comprise one or more meta data information for what action the target individual (e.g., Tiger Woods) has just taken at that moment, how many other people received that limited edition NFT, images of that moment, and etc., which can be stitched or combined together into a multi-faced and mixed-media NFT.

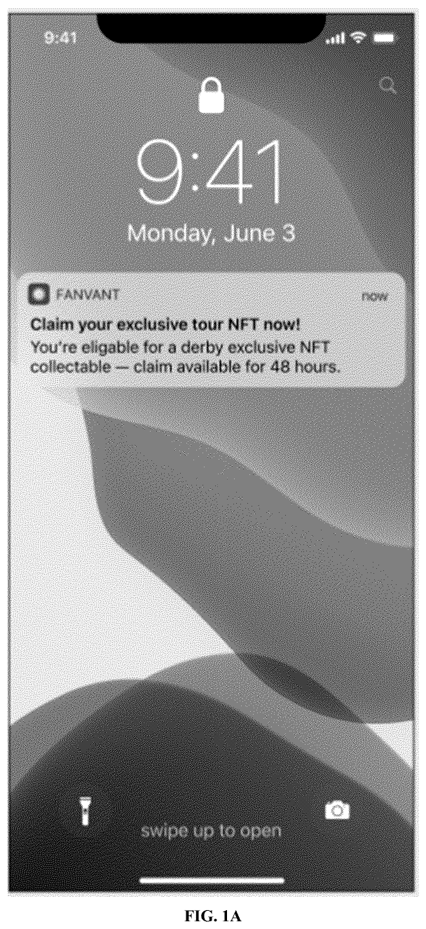

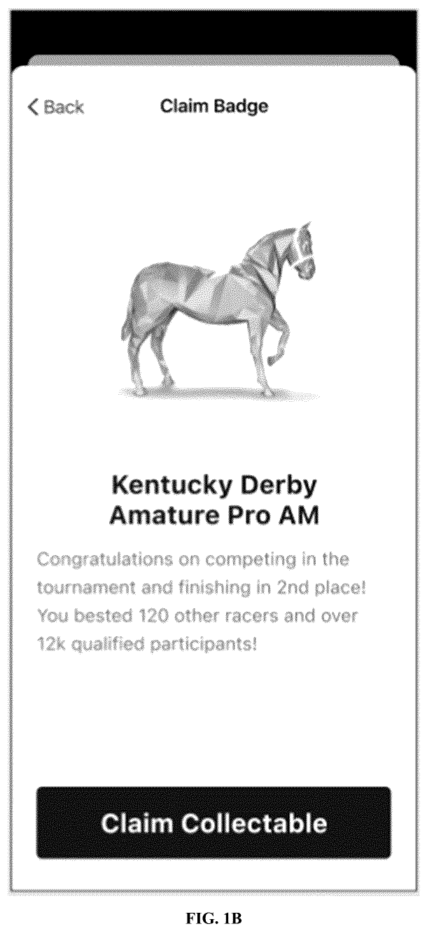

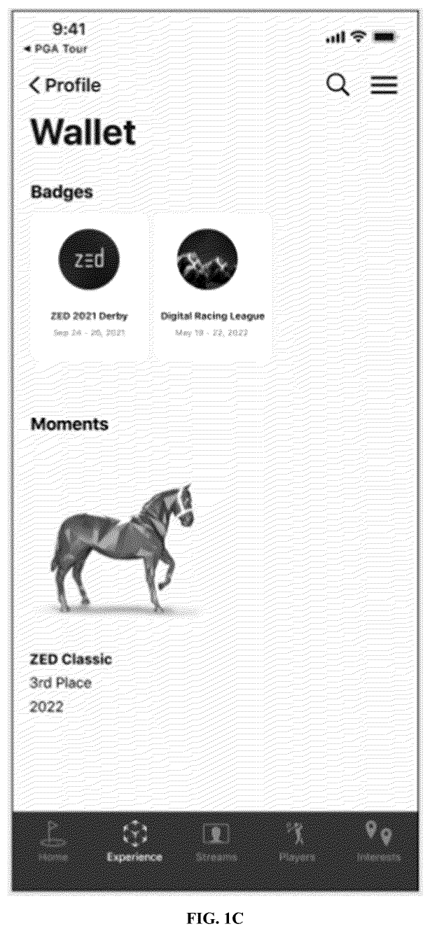

FIGS. 1A-1C show an example of a notification, a GUI for collecting an NFT, and a GUI showing badges and moments, respectively. In this example, a user receives a notification on a mobile phone that the user is eligible for receiving an NFT. The notification states “Claim your exclusive tour NFT now! You're eligible for a derby exclusive NFT collectable-claim available for 48 hours”. Tapping the notification can display the GUI for collecting the NFT. The NFT can be for competing in an event (e.g., a tournament), an achievement (e.g., finishing in 2^{nd} place), and can contain meta data records for the event or the achievement (e.g., how many other participated in the event). Claiming the NFT can display the GUI showing badges and moments.

In another example, a user participates in a marathon and competes against other user participants. The user can be issued an NFT based on the user's performance relative to other users. The NFT can be issued with, or could memorialize a note which states: “You finished 2nd in your age group with a time of X”, “You beat X other runners”, “Your race intervals are as follows: X”, and any other similar message memorializing the event participation.

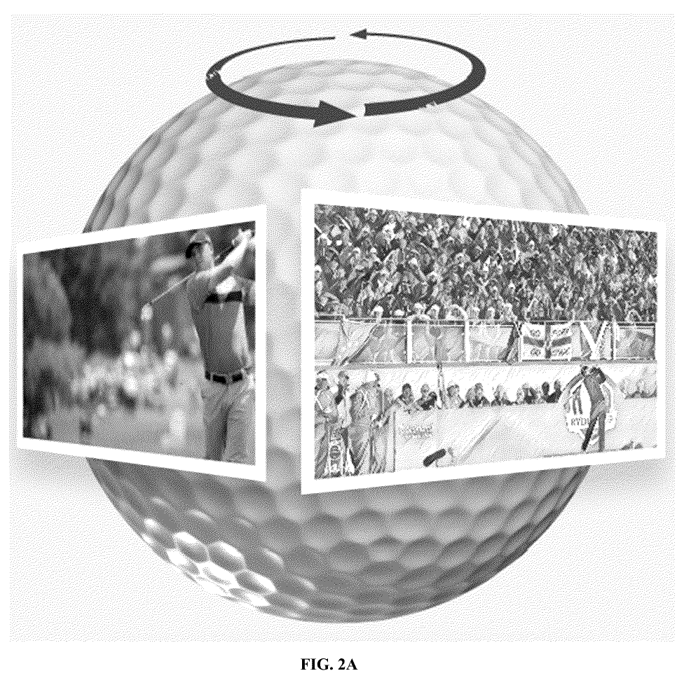

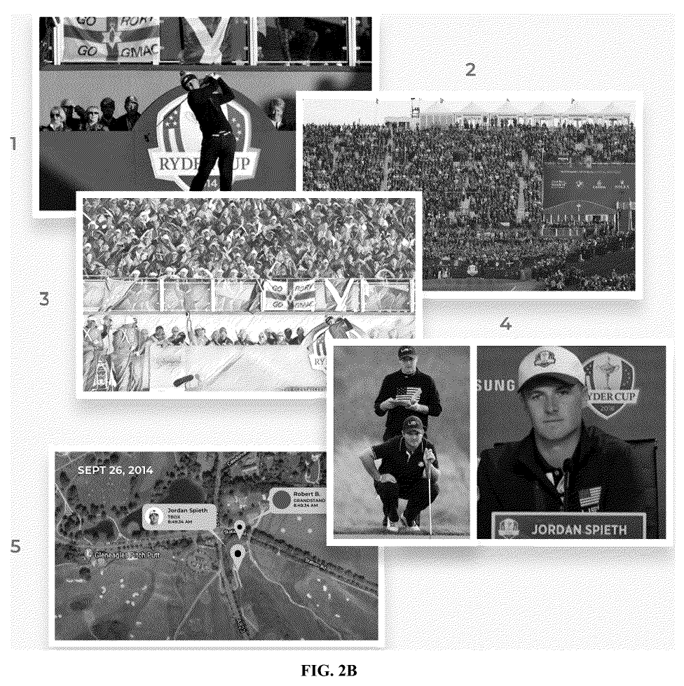

FIGS. 2A-2B show an example of a multi-faced and mixed-media NFT. This example of NFT comprises (1) a user generated content (UGC), (2) a highlight from a broadcast, (3) an artistic rendering, (4) a minting ledger, and (5) a commentary from a player. The facets of the NFT can be displayed in conjunction with a digital object associated with the type of entertainment or sport of the NFT (e.g., a golf ball).

Thus, such NFT content may include images generated from other users or from third party sources which can include UGC that captures the individual and/or the user at that moment of creation or issuance of the NFT. The UGC or a broadcast partner can highlight of the individual's last event action (e.g., Tiger Woods' winning last shot) prior to the issuance of the NFT. NFT content can also contain a static photograph, artistic skins/overlays/digital art unique to the NFT, a map of the users relative locations at the time of minting the NFT, course information, audio content, and etc.

Other examples of what the NFT can include are: a player photograph with an autograph; a UGC of the moment; a photograph of a moment that morphs into a painting; course information, a ticket; an audio and/or a video of an interview with an individual; and a map of where when a UGC Minted. The back of the NFT can be a ledger.

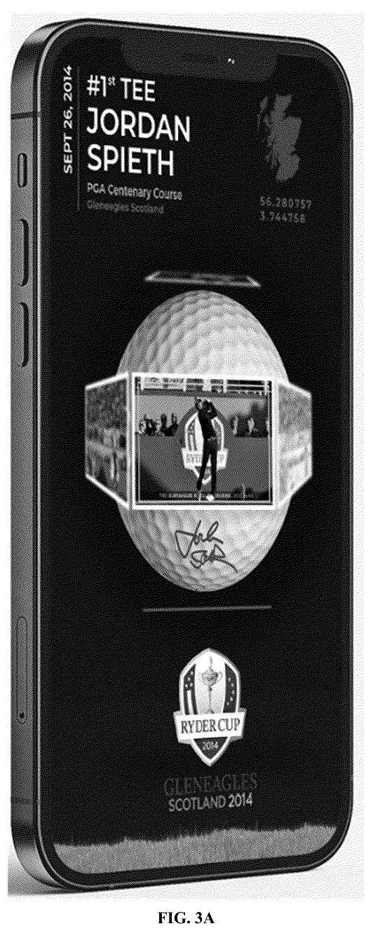

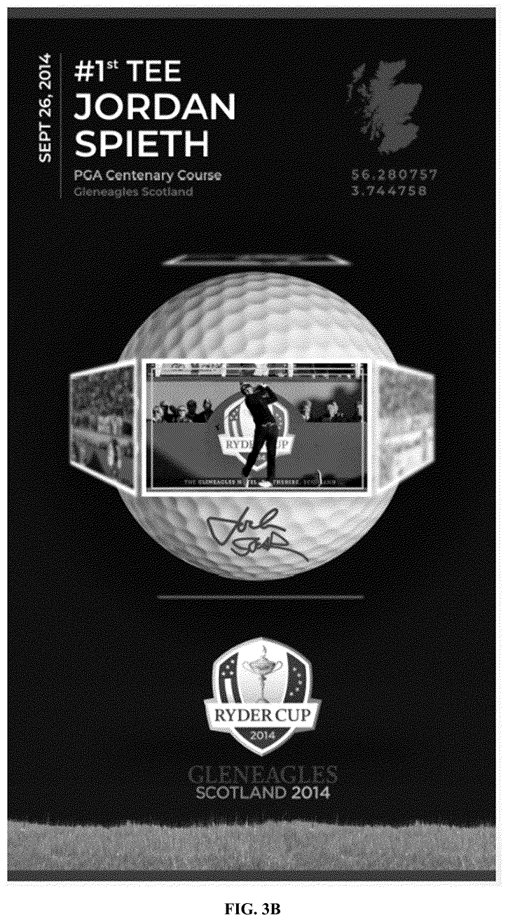

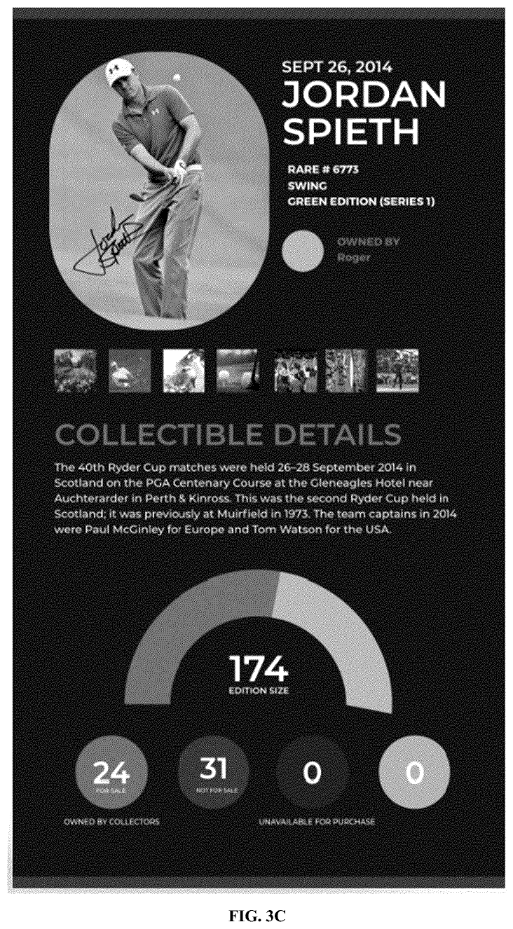

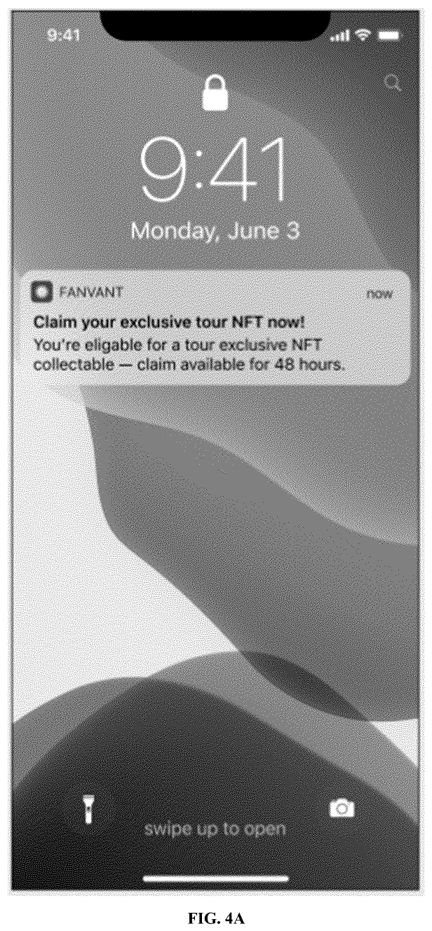

The multi-faced NFT can be displayed with or comprise memorialized meta data. FIGS. 3A-3C show examples of an NFT with meta data. For example, the meta data can comprise the name of the individual memorialized. The meta data can comprise coordinates (e.g., longitude and latitude) of where the NFT was memorialized. The meta data can comprise a map or a shape of a state (or country) where the NFT was memorialized. The meta data can comprise a logo or a name of the event at which the NFT was memorialized. The meta data can comprise a summary or a brief description of the event. The meta data can comprise a name or an alias of the owner of the NFT. The meta data can comprise whether the NFT is for sale. The meta data can comprise how many similar or identical NFTs exist. The meta data can comprise how many of the similar or identical NFTs are for sale.

### Example 7: NFT Generated Based on Event Attendance and Game Participation

A user attends a sports/entertainment event and participates in a game where the goal is to get within a defined distance of a target athlete/entertainer, or multiple different athletes/entertainers, for a defined number of times over the course of the event or within a defined limited period of time. For example, a golf fan user can receive an NFT for physically following a particular golfer over at least “X” number of holes in one day, wherein “X” can be an integer greater than 0, and can receive an NFT commemorating the accomplishment. The NFT can record the date, time, holes followed, athlete's scoring/highlights over that period.

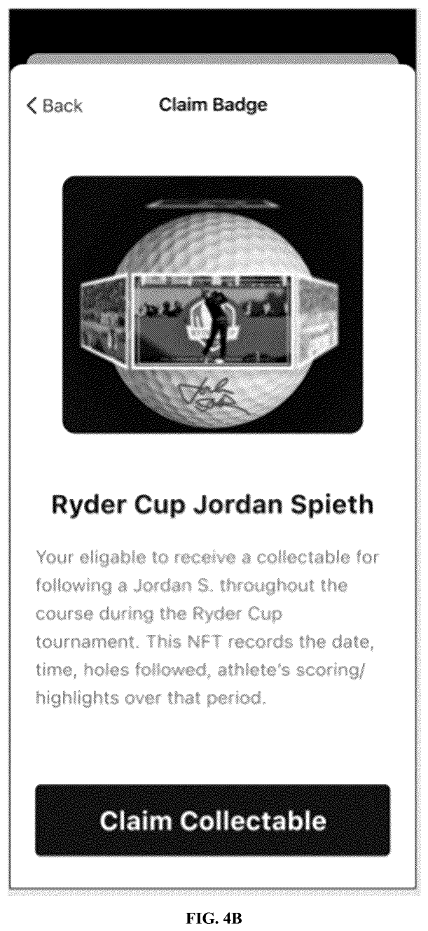

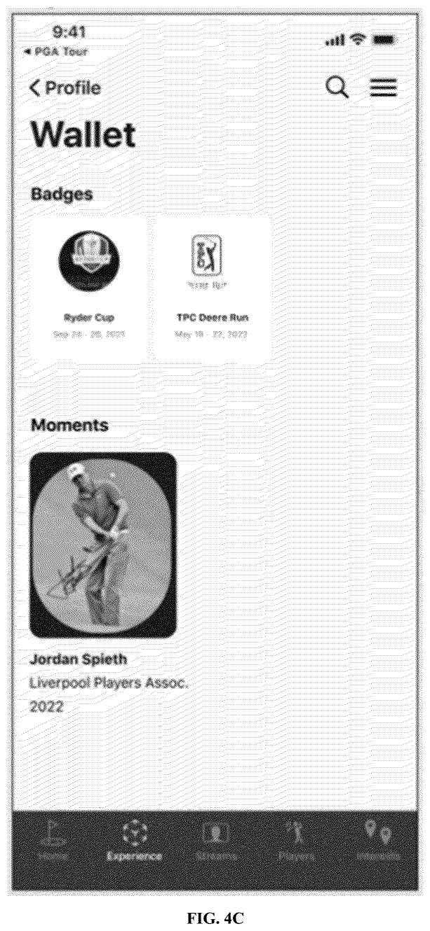

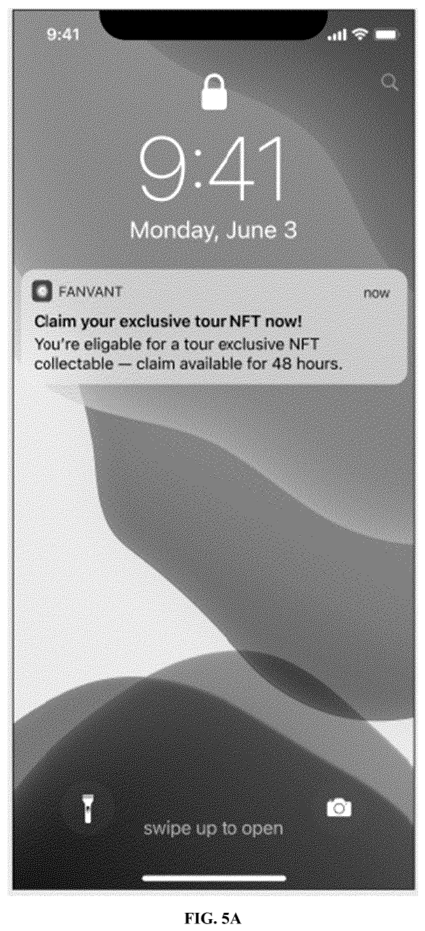

FIGS. 4A-4C show an example of a notification, a GUI for collecting an NFT, and a GUI showing badges and moments, respectively. A user receives a notification on a mobile phone that the user is eligible for receiving an NFT. The notification states “Claim your exclusive tour NFT now! You're eligible for a tour exclusive NFT collectable—claim available for 48 hours”. Tapping the notification can display the GUI for collecting the NFT.

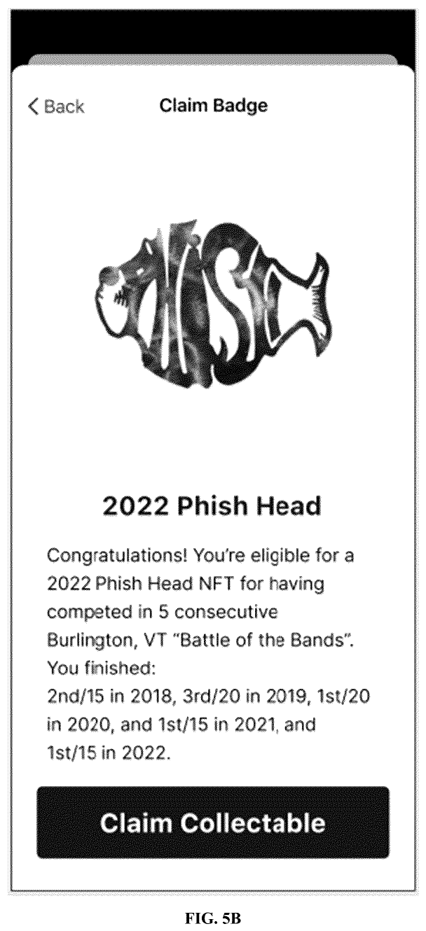

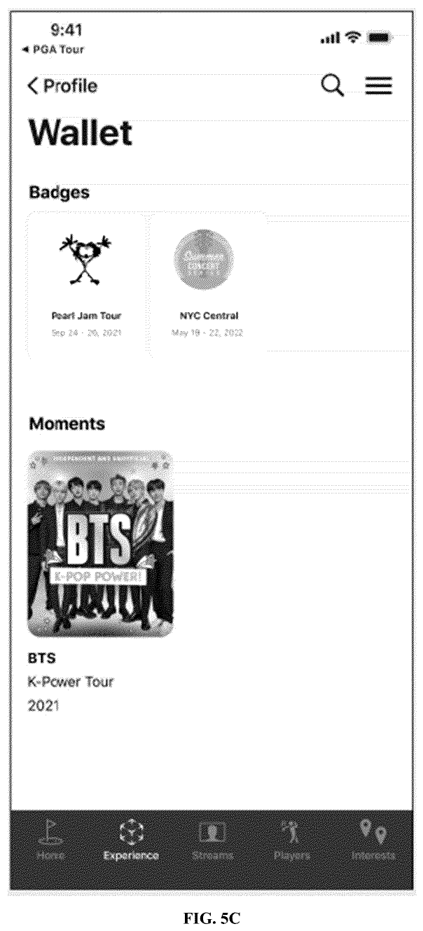

In another example, a user attending a multi-stage concert event can be issued an NFT if the user physically goes to at least X stages in one day. The NFT can record the date, time, stages attended, entertainers performing during the users attendance, songs heard, distance covered, and the number of other users who received a similar NFT. FIGS. 5A-5C show an example of a notification, a GUI for collecting an NFT, and a GUI showing badges and moments, respectively.

In another example, a user that attends several events where a particular athlete/team/entertainer/band performed over a defined period of time can receive an NFT that commemorates the accomplishment, and unlocks access to experiences/products that are only eligible to other users of similar accomplishments. The number of NFTs can be limited, and may be issued based on a series of qualifying actions conditioned upon the user's location relative to his physical attendance at the series of targets (events).

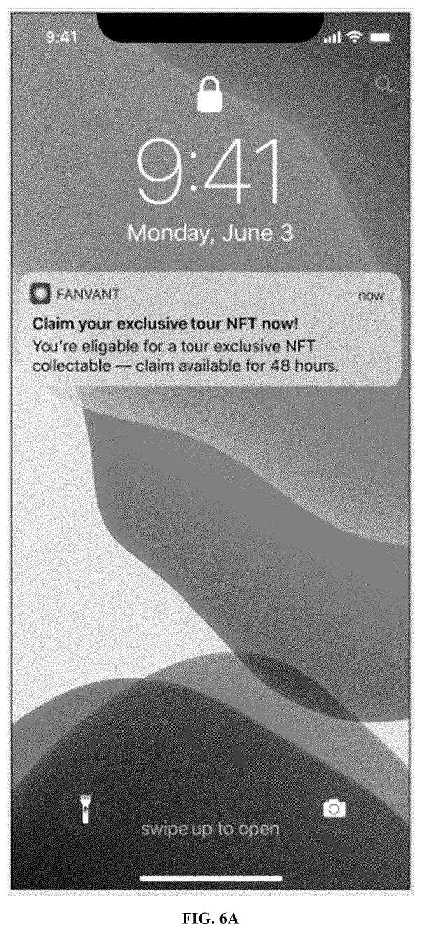

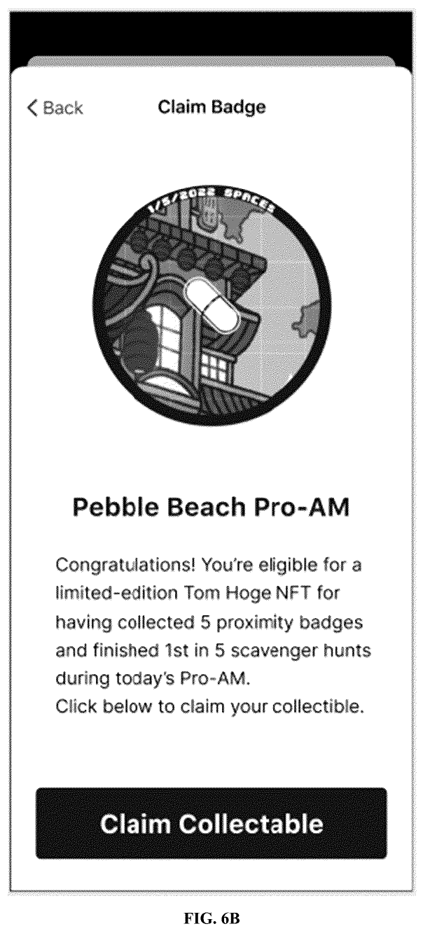

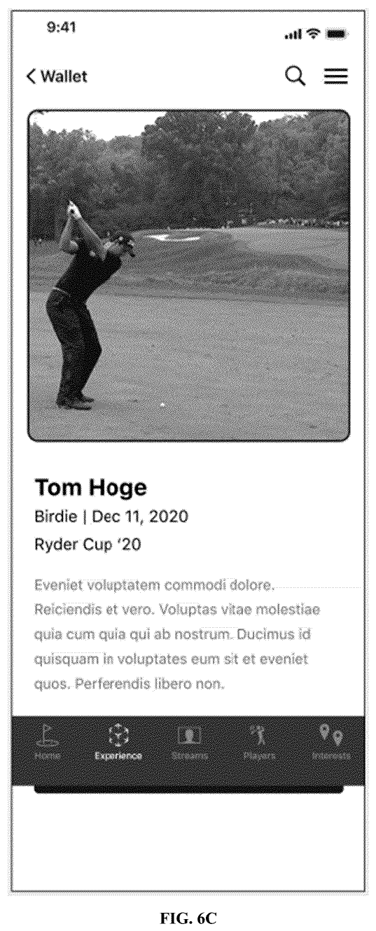

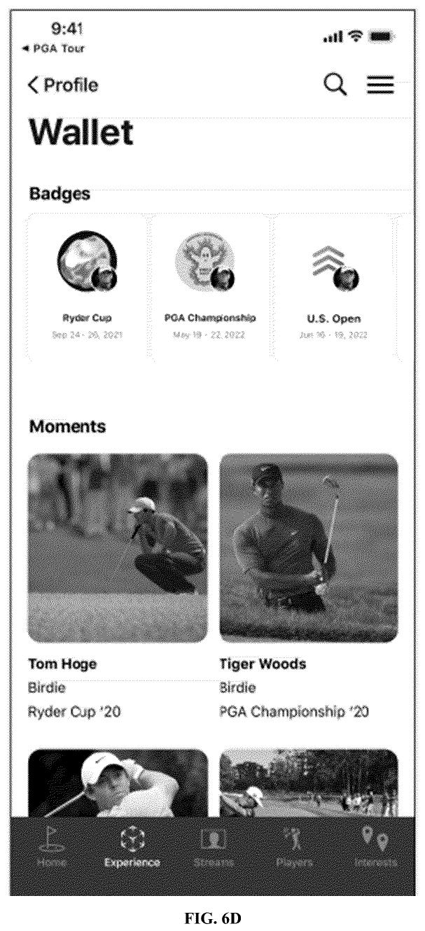

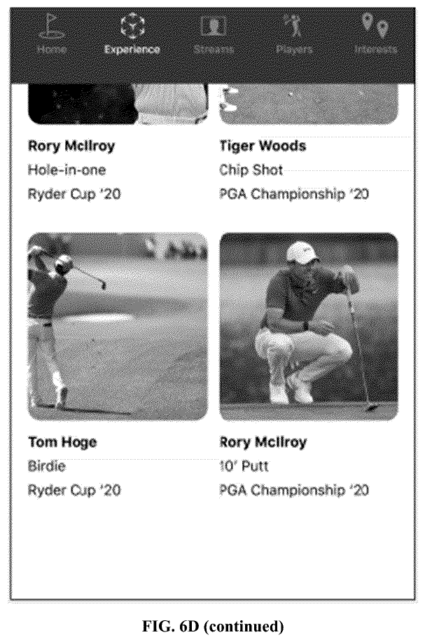

FIGS. 6A-6D show an example of a notification, a GUI for collecting an NFT, an NFT, and a GUI showing badges and moments, respectively. A user can be issued an NFT when the user fulfills certain conditions, for example, finishing a scavenger hunt. The issued NFT can provide a brief description of the individual and of the event for which the NFT was created.

In another example, a user that participates in and competes against other user(s) over several sporting or entertainment events in a row can become eligible for an NFT commemorating the accomplishment. For instance, a user runs in five 10-K races in a row and competes against the user's family members in each of those races can become eligible for an NFT that commemorates the experience. The NFT can be marked with a note such as, “You raced against User X in Y event Z times in a row over this period of time, the results of each race were W”. The NFT can include video, audio, photographic, digital art unique and representative of the experience. In another instance, a user that is a musician can compete in a local battle of the bands competition X years in a row. The NFT can record the user's results from each event, the other bands (e.g., other users) competed against, notable fans in attendance (e.g., other users), meta data from other sources about the event. The meta data can include number of fans at each performance, number of bands that entered, the number of bands that competed, weather data, and etc.

For example, the term “a NFT” includes a plurality of NFTs, including combinations of NFTs with other digital forms.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-81. (canceled)

82. A computer-implemented method for generating a non-fungible token (NFT) of an individual and/or an experience between the user and the individual, comprising:
(a) obtaining a set of pre-determined criteria relating to the experience between the user and the individual;
(b) obtaining a first set of location information and time information of the user and a second set of location information and time information of the individual;
(c) processing the first set of location information and time information and the second set of location information and time information using the set of pre-determined criteria; and
(d) generating the NFT of the individual and/or the experience based at least in part on the processing in (c).

83. The computer-implemented method of claim 82, wherein the NFT comprises a single-faced graphical representation.

84. The computer-implemented method of claim 83, wherein the single-faced graphical representation comprises an image file, wherein the image file comprises at least one of an image of the individual, an image created by the individual, location information of the individual, time information of the individual, and an authentication of the NFT.

85. The computer-implemented method of claim 83, wherein the single-faced graphical representation comprises an audio file, wherein the audio file comprises at least one of audio of the individual, audio created by the individual, location information of the individual, time information of the individual, and an authentication of the NFT.

86. The computer-implemented method of claim 83, wherein the single-faced graphical representation comprises a video file, wherein the video file comprises at least one of a video of the individual, a video created by the individual, location information of the individual, time information of the individual, and an authentication of the NFT.

87. The computer-implemented method of claim 82, wherein the NFT comprises a multi-faced graphical representation.

88. The computer-implemented method of claim 82, wherein the experience relates to an interaction and/or a proximity between the user and the individual.

89. The computer-implemented method of claim 88, wherein the set of pre-determined criteria relating to the interaction and/or proximity comprises a criterion that the user is required to be attending an entertainment event of the individual.

90. The computer-implemented method of claim 82, wherein (b) comprises using a beacon or a global positioning system (GPS) to obtain location information and/or time information of the user and/or the individual.

91. The computer-implemented method of claim 82, wherein (b) is performed using a smartphone or a smartwatch of the user.

92. The computer-implemented method of claim 82, wherein (d) comprises incorporating user generated content of the user.

93. The computer-implemented method of claim 92, wherein the user generated content comprises an image or a video of the user and/or the individual.

94. The computer-implemented method of claim 82, further comprising:
(e) transmitting the NFT of the individual and/or the experience to the user.

95. The computer-implemented method of claim 82, further comprising generating a plurality of NFTs of the individual and/or the experience.

96. The computer-implemented method of claim 82, further comprising generating at least one of a numerical identifier, a date identifier, and a time identifier for the NFT.

97. The computer-implemented method of claim 82, further comprising generating an authentication of the NFT.

98. The computer-implemented method of claim 97, wherein the authentication is generated using a blockchain.

99. The computer-implemented method of claim 82, further comprising generating a sale of the NFT.

100. The computer-implemented method of claim 99, wherein the sale is completed using a blockchain.

101. The computer-implemented method of claim 82, wherein the NFT comprises or is associated with a meta data, wherein the meta data comprises: (i) a coordinate based on the set of location information, (ii) a title of an event, (iii) a description of the event, or (iv) a number of copies of the NFT generated.
